(19) United States
(12) Patent Application Publication
(10) Pub. No.: US 2025/0305286 A1
(43) Pub. Date: Oct. 2, 2025

(54) RECYCLABLE ARCHITECTURAL ACOUSTIC PRODUCTS AND SUSPENSION THEREOF

(71) Applicant: AUTEX INDUSTRIES LIMITED, Auckland (NZ)

(72) Inventors: Jonathan Seymour MOUNTFORT, Auckland (NZ); Luke Clifford WALKER, Auckland (NZ); Samuel William WELLS, Auckland (NZ); Gregor Allan Storey, Auckland (NZ); Miriam Rose MACLEAN, Auckland (NZ)

(73) Assignee: AUTEX INDUSTRIES LIMITED, Auckland (NZ)

(21) Appl. No.: 19/090,258

(22) Filed: Mar. 25, 2025

(30) Foreign Application Priority Data
Mar. 26, 2024 (NZ) 809528

(51) Int. Cl. E04B 9/04; E04B 9/22; E04B 9/34

(52) U.S. Cl. CPC E04B 9/0414; E04B 9/22; E04B 9/34

(57) ABSTRACT

Disclosed is an acoustic architectural product that is fully recyclable without requiring dismantling or separation of its components. The product comprises an acoustic component and PET clips and/or connectors that engage with the PET component. The invention also includes a suspension system for supporting the product without additional bracing.

### FIELD OF THE INVENTION

The invention relates to an acoustic architectural product.

More particularly, but not exclusively, it relates to acoustic architectural products assembled with thermoplastic fixings, making them separable, often homogeneous products suitable for recycling. It also relates to a method of fixing thermoplastic (preferably needle-punched PET or natural fibre-based) acoustic elements to a wall, ceiling, or other substrate to allow for disassembly, recycling/upcycling, or replacement, and/or to a suspension system suitable for suspending such acoustic elements.

### BACKGROUND TO THE INVENTION

This invention relates in particular to needle punched PET acoustic elements for attachment to walls or ceilings but can also apply to other similar acoustic elements such as plastics acoustic elements. Needle punched PET acoustic elements can be decorative and provide good sound absorption properties.

PET is the common abbreviation for—poly ethylene terephthalate.

PET, unlike natural polymers, is a non-degradable polymer in the natural environment leading to environmental pollution when it is discarded after use. Consequently, it is desirable to recycle it (sometimes called upcycle) wherever possible.

However existing methods of attaching them to walls or ceilings typically involves the use of metal components securely attached to and forming part of the acoustic elements, so that removal of the acoustic elements, for example if one is damaged and needs to be replaced, or if the fit out needs to be changed, means that they cannot readily be recycled or upcycled without labour intensive cutting or removal of the non-PET components. It is worse if the non-PET (typically metal) components are fixed to the PET acoustic elements with an adhesive. As the use of an adhesive to secure a PET acoustic component, renders the PET unable to be recycled as the adhesive does not comply with standards relating to the recycling of PET material.

Some acoustic elements are suspended from substrates including ceilings (this term also includes the structure over). Suspended ceiling systems are well known but a major burden of existing systems is the requirement to brace them in earthquake prone areas. This is time consuming and inconvenient. Often a wire-hung supporting ceiling is assembled first and then the laborious process of diagonal bracing is added—this is usually ad-hoc, and often over-engineered to pass inspection and unsightly. There is a need for an improved system which is less labour intensive whether it is used for suspending PET acoustic elements or other types of suspended ceilings.

### PRIOR REFERENCES

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications may be referred to herein; this reference does not constitute an admission that any of these documents form part of the common general knowledge in the art, in New Zealand or in any other country.

### OBJECT OF THE INVENTION

It is an object of the invention to provide a method and components for fixing of acoustic elements, such as PET acoustic elements, to or suspended from a substrate that allows for recycling of such acoustic elements or which ameliorates some of the disadvantages and limitations of the known art and/or at least provide the public with a useful choice.

Additional or alternative object of the invention is to provide recyclable architectural acoustic product(s), suspension system(s) and/or component(s) thereof which ameliorates some of the disadvantages and limitations of the known art and/or at least provide the public with a useful choice.

### SUMMARY OF INVENTION

In general, one aspect of the present invention involves novel products and a novel method of a fixing of acoustic elements, such as PET acoustic element, to or from a substrate to allow for recycling of the acoustic elements without the need to separate the PET from other materials.

In one aspect the invention provides an acoustic architectural product which can be recycled without dismantling or separation of its component parts, the product comprising an acoustic component and at least one clip (or plastic clip) and/or at least one connector (or plastic connector) engaging or configured to physically engage with the acoustic component, wherein the or each clip and/or connector are made from PET.

In one embodiment, the product is or comprises a substantially hollow beam folded from a panel of needle punched PET.

In one embodiment, the product comprises a plurality of plastic clips and/or a plurality of connectors that are configured to engage with the PET component.

In one embodiment, the acoustic component is a substantially hollow beam folded from a panel of a thermoplastic material, a needle punched PET, or a natural fibre based component capable of being recycled and/or upcycled.

In one embodiment, the beam is substantially rectangular in cross section.

In one embodiment, the beam is or is configured to be held together by the clip(s), the clip(s) being internal clips moulded from PET.

In one embodiment, the beam has a longitudinal groove along a top face into which connector(s) can be inserted, the connector(s) being moulded from PET.

In one embodiment, the beam has a short internal return (fold(s) or flange(s)) on either or each side of the groove.

In one embodiment, the clip(s) are resilient and designed to hold the short internal return(s) (fold(s) or flanges) together.

In one embodiment, the at least one connector has or comprises a holding portion which can be inserted into and held in the groove.

In one embodiment, the holding portion is an arrowhead portion.

In one embodiment, the product comprises a plurality of such beams.

In one embodiment, the product is or comprises a grid made up of intersecting substantially hollow beams, preferably folded from a panel of needle punched PET.

In one embodiment, the product comprises a plurality of beams, each beam being a substantially hollow beam folded from a panel of needle punched PET.

In one embodiment, the product comprises one or more fins of needle punched PET, each fin having a longitudinal groove along a narrow face of the fin and one or more connectors or clip assemblies inserted into the longitudinal groove, the or each connector or the or each clip assembly made solely of PET.

In another aspect the invention provides a suspension system suitable for suspending acoustic elements from a structure without the need for additional bracing comprising a plurality of dropper brackets each capable of being connected to the structure over and connectable to a dropper tube, the dropper tube being connectable to a rail bracket which in turn can support a rail which is connectable to and can support a PET connector of an acoustic architectural product.

In one embodiment, the dropper bracket has a swivel connection between its mounting and a socket adapted to receive a dropper tube to provide at least one degree of freedom of movement of the socket relative to the mounting.

In one embodiment, the dropper bracket has a universal joint allowing two degrees of freedom of movement of the socket relative to the mounting.

In one embodiment, the rail has a symmetrical cross section having a pair of longitudinal grooves, one groove capable of retaining an inserted rail bracket and the other capable of supporting a head of a PET connector of an acoustic architectural product.

In one embodiment, the rail has a symmetrical cross section defining a pair of longitudinal grooves, one groove being configured to retail a rail bracket and the other groove being configured to support a coupling member of the ET connector of the acoustic architectural product.

This has the advantage that the acoustic elements can be connected to the substrate or a suspension system, and if any of the acoustic elements is removed from the substrate or suspension system, each entire PET acoustic element can be recycled without the need for the separation of materials.

In one aspect the invention provides a suspension system suitable for suspending acoustic elements from a structure without the need for additional bracing comprising at least one dropper bracket that is capable of being connected to the structure over and connectable to a dropper tube, the dropper tube being connectable to a rail bracket which in turn can support a rail which is connectable to and can support a PET connector of an acoustic architectural product.

In one embodiment, the at least one dropper bracket has a swivel connection between its mounting and a socket adapted to receive a dropper tube to provide at least one degree of freedom of movement of the socket relative to the mounting.

In one embodiment, the at least one dropper bracket allows or has a universal joint allowing two degrees of freedom of movement of the socket relative to the mounting.

In one embodiment, the rail has a symmetrical cross section having a pair of longitudinal grooves, one groove capable of retaining an inserted rail bracket and the other capable of supporting at least a head/coupling member of a PET connector of an acoustic architectural product.

In one embodiment, the rail has a symmetrical cross section defining a pair of longitudinal grooves, one groove being configured to retail a rail bracket and the other groove being configured to support a coupling member of the ET connector of the acoustic architectural product.

### DEFINITIONS

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

It is known to those with skill in the art of patenting, that the word ‘substantially’ can in some instances, be used to broaden a term. It should be stated that, in this specification, use of the word ‘substantially’ with a term, to define a feature(s), gets all the benefit (i.e., the benefit of broadening) afforded by the use of the word ‘substantially’, and also includes within its scope feature(s) being that the term exactly (without broadening). For example, if a feature is described/defined in this specification as being ‘substantially vertical’, then that includes, within its scope, the feature being ‘close’ to vertical (in so far as the word ‘substantially’ is deemed to broaden the term ‘vertical’), and also includes within its scope the features being ‘exactly’ vertical.

For purposes of the description hereinafter, the terms “upper”, “lower”, “right”, “left”, “vertical”, “horizontal”, “top”, “bottom”, “lateral”, “longitudinal” and derivatives thereof shall relate to the invention as it is oriented in the drawing figures. However, it is to be understood that the invention may assume various alternative variations, except where expressly specified to the contrary. It is also to be understood that the specific devices illustrated in the attached drawings, and described in the following description are simply exemplary embodiments of the invention. Hence, specific dimensions and other physical characteristics related to the embodiments disclosed herein are not to be considered as limiting.

As used hereinbefore and hereinafter, the term “and/or” means “and” or “or”, or both.

As used hereinbefore and hereinafter, “(s)” following a noun means the plural and/or singular forms of the noun.

Acoustic architectural product refers to a sound absorbing or sound attenuating product of a particular shape or collection of shapes that may be aesthetically pleasing.

PET refers to polyethylene terephthalate.

“PET fixing component” as used herein refers to a component made of PET (whether virgin PET or recycled PET) which can be attached to a PET acoustic elements without the use of an adhesive.

### BRIEF DESCRIPTION

The invention will now be described, by way of example only, by reference to the accompanying drawings.

Sound dampening (acoustic) products for offices and other interior spaces are often made of PET. They can be made in a number of different aesthetically pleasing shapes, so as to fit in with the decor of the building and yet, function to dampen excessive sound.

With products made from needle punched PET, whether shapes held together by adhesives, or by metal clips, or other fixing components, the problem is that these composite acoustic products cannot be recycled unless all of the non-PET components can be removed. This is a particular problem if adhesives are used because the adhesives contaminate the fibres of the PET, preventing it from being recycled. Removal of metal components on the other hand is possible but is labour-intensive and makes recycling difficult.

### BRIEF DESCRIPTION OF THE DRAWINGS

The invention will now be described by way of example only and with reference to the drawings in which:

FIG. 1 shows a hollow beam made of needle punched PET, together with a connector and clip according to one embodiment of the present invention.

FIG. 1A shows the hollow beam of FIG. 1, with the connector slid to a different position than that in FIG. 1.

FIG. 2 shows a grid of hollow beams made of needle punched PET, according to one embodiment of the present invention.

FIG. 3 shows how the hollow beams made of needle punched PET in FIG. 2 are fitted together.

FIG. 4 shows how the beam of FIG. 1 can be folded from a substantially flat needle-punched PET panel.

FIG. 5 is an end perspective of the beam of FIG. 1, showing the folded needle punched PET material held together by clips and connectors.

FIG. 5A is an end view of the beam of FIG. 1, with the end cap removed, showing how the folded needle punched PET material is held together by clips and connectors.

FIG. 5B is another end perspective view of the beam of FIG. 1, with the end cap removed, showing how the folded needle punched PET material is held together by clips and connectors.

FIG. 6 is a perspective view of the clip shown in FIG. 5.

FIG. 6A is an end view of the clip of FIG. 6.

FIG. 7 shows an endcap inserted into the end of a folded beam that is the beam of FIG. 1.

FIG. 8 shows the endcap partially removed to illustrate the barbs which can grip the inside of the folded beam.

FIG. 9 is an interior view of the endcap of FIG. 7, according to one embodiment of the present invention.

FIG. 10 is a perspective view of the endcap of FIG. 9, showing the interior and bottom of the endcap.

FIG. 10A is the exterior view of the endcap of FIG. 9.

FIG. 10B is the view of the endcap of FIG. 9, showing the interior and top of the endcap.

FIG. 11 is a top perspective view of a connector for the folded beam, according to one embodiment of the present invention. It has a top mushroom shape engagement member/coupling member which is configured to clip into a rail and the lower portion in the form of an arrowhead portion designed to be inserted into and lock into the folded beam.

FIG. 11A is an underside perspective view of the connector of FIG. 11.

FIG. 12 is a modified connector designed to fit directly onto walls or ceilings, and thus omitting the mushroom shaped engagement member/coupling member and instead comprising apertures for fixing screws or the like.

FIG. 13 is an underside perspective view of the connector of FIG. 12.

FIG. 14 is an endcap variant in the form of a wall mount according to one embodiment of the present invention, the wall mount being designed to support the end of a beam to prevent it from sliding.

FIG. 14A is a perspective view of the wall mount of FIG. 14, showing the exterior of the wall mount.

FIG. 14B is a perspective view of the wall mount of FIG. 14, showing the interior of the wall mount.

FIG. 15 shows a suspension system according to one embodiment of the present invention, depicting the assembly of the different suspension components of the suspension system.

FIG. 16 shows an assembled dropper bracket/base bracket of the suspension system of FIG. 15 which can be mounted on the structure to suspend at least the dropper tube of the suspension system of FIG. 15.

FIG. 17 shows the minor access movement of the dropper fastening (dropper tube fastening member) of the dropper bracket of FIG. 16.

FIG. 18 shows the major access movement of the dropper fastening (dropper tube fastening member) of the dropper bracket of FIG. 16.

FIG. 19 shows an assembled dropper bracket/base bracket variant, according to one embodiment of the present invention.

FIG. 19A shows a further assembled dropper bracket/base variant, according to one embodiment of the present invention.

FIG. 20 shows an example of a rail bracket according to one embodiment of the present invention, fastened in a rail.

FIG. 21 shows a rail bracket variant according to one embodiment of the present invention, that is disengaged from a rail, wherein the rail is sheet metal rail.

FIG. 21A shows the rail bracket of FIG. 21 engaged with the rail.

FIG. 21B shows a perspective view of the rail of FIG. 21A according to one embodiment of the present invention.

FIG. 21C is an end elevation view of the rail of FIG. 21A.

FIG. 22 shows another view of the rail bracket of FIG. 21 engaged with the rail.

FIG. 23 shows an exploded view of a slotted PET fin and a clip assembly according to one embodiment of the present invention which can be supported by the rail of FIGS. 20-22.

FIG. 24 shows an end elevation of the rail bracket of FIG. 22 located in the rail and showing symmetry lead-in profile.

FIG. 25 shows an example of a rail joiner together with the rail bracket and the rail of FIG. 21.

FIG. 26 shows the clip assembly being attached to the fin of FIG. 23.

FIG. 27 shows another example of the fin with another clip assembly according to an embodiment of the present invention in place.

FIG. 27A shows a side elevation view of the fin of FIG. 27 with the clip assembly in place.

FIG. 28 shows a side elevation view of the fin of FIG. 26 being engaged with the clip assembly of FIG. 27, a portion of the clip assembly is inserted into the lower channel of the rail of FIG. 21B.

FIG. 28A shows a perspective view of the fin and clip assembly of FIG. 28 but without the rail.

FIG. 28B shows an exploded view of the fin and clip assembly of FIG. 28A. FIG. 28C shows the fin and clip assembly of FIG. 28, with the clip assembly engaged with the fin but disengaged from the rail of FIG. 28.

FIG. 28D is the perspective view of the of the fin and clip assembly of FIG. 28, with the clip assembly engaged with the fin and the rail of FIG. 28.

FIG. 29 shows a perspective view of another example of the fin with the clip assembly of FIG. 26 in place, and the clip assembly being in an assembled condition.

FIG. 30 shows a perspective view of the fin of FIG. 29 but with the clip assembly of FIG. 27 in place.

FIG. 31 shows a side elevation view of fin of FIG. 30 being supported by the clip assembly of FIG. 27 being engaged with the clip assembly of FIG. 27, a coupling portion of the clip assembly is inserted into the lower channel of the rail of FIG. 21B.

FIG. 32 shows a perspective view of another example of the fin with the clip assembly according to another preferred example of the present invention in place, with the clip assembly being in an assembled condition.

FIG. 33 shows a perspective view of another example of the fin with the clip assembly of FIG. 33 being attached to the fin, with the clip assembly not yet in an assembled condition.

FIG. 34 shows an exploded view of the fin and clip assembly of FIG. 33.

FIG. 35 shows a perspective view of the fin of FIG. 33 with the clip assembly of FIG. 33 in place, and the clip assembly being in an assembled condition.

FIG. 36 shows the perspective view of the fin of FIG. 32 with the clip assembly according to another preferred embodiment of the present invention in place.

FIG. 37 shows the perspective view of the fin of FIG. 33 with the clip assembly of FIG. 36 in place.

FIG. 38 shows an exploded view of the fin and clip assembly of FIG. 37.

FIG. 39 shows an end elevation view of the fin of FIG. 32 without a clip assembly.

FIG. 40 shows an end elevation view of the fin of FIG. 33 without a clip assembly.

FIG. 41 shows an end elevation view of the fin of FIG. 27 without a clip assembly.

FIG. 42 shows an end elevation view of a fin according to another preferred embodiment of the present invention without a clip assembly.

FIG. 43 shows an end elevation view of the fin of FIG. 23 without a clip assembly.

FIG. 44 shows an end elevation view of the fin of FIG. 29 without a clip assembly.

FIG. 45 shows the fin of FIG. 42 in an unfolded condition.

FIG. 46 shows a perspective view of the clip assembly of FIG. 27.

FIG. 47 shows an end view of the clip assembly of FIG. 46.

FIG. 48 shows a perspective view of a clip assembly according to one preferred embodiment of the present invention.

FIG. 49 shows an end view of the clip assembly of FIG. 48.

FIG. 50 shows a perspective view of the clip assembly of FIG. 23 in an assembled condition.

FIG. 51 shows an end view of the clip assembly of FIG. 50.

FIG. 52 shows an end view of the clip assembly of FIG. 50 without the connector of the clip assembly.

FIG. 53 shows a perspective view of a clip assembly of FIG. 32.

FIG. 54 shows an end view of the clip assembly of FIG. 53.

FIG. 55 shows the perspective view of the connector of the clip assembly of the various embodiments of the present invention.

FIG. 56 is a top perspective view of a connector variant for the folded beam of FIG. 1, according to one embodiment of the present invention.

FIG. 57 is an underside perspective view of the connector of FIG. 56.

FIG. 58 is a top perspective view of another connector variant for the folded beam of FIG. 1, according to one embodiment of the present invention.

FIG. 59 is an underside perspective view of the connector of FIG. 58.

FIG. 60 is a top perspective view of a yet further connector variant for the folded beam of FIG. 1, according to one embodiment of the present invention.

FIG. 61 is an underside perspective view of the connector of FIG. 60.

FIG. 62 is an end perspective view of the beam of FIG. 1, with the end cap removed, showing how the folded needle punched PET material is held together by clip of FIG. 6 and connector of FIG. 58.

FIG. 63 is an interior view of the endcap variant, according to one embodiment of the present invention, the end cap can be inserted into the end of a folded beam that is the beam of FIG. 1.

FIG. 64 is a perspective view of the endcap of FIG. 63, showing the exterior and top of the endcap of FIG. 63.

FIG. 65 is the exterior view of the endcap of FIG. 63.

FIG. 66 is another end perspective view of the beam of FIG. 1, with the end cap removed, showing how the folded needle punched PET material is held together by clip of FIG. 6 and connector of FIG. 58.

FIG. 67 is an end view of the beam of FIG. 1, with the end cap removed, showing how the folded needle punched PET material is held together by clip of FIG. 6 and connector of FIG. 58.

FIG. 68 is an underside perspective view of the beam of FIG. 1, with the end cap removed, showing how the folded needle punched PET material is held together by clip of FIG. 6 and connector of FIG. 58.

### DETAILED DESCRIPTION

The following description will describe the invention in relation to preferred embodiments of the invention, namely the design of and the fixing of PET acoustic elements to allow for recycling.

The invention is in no way limited to these preferred embodiments as they are purely to exemplify the invention only and that possible variations and modifications would be readily apparent without departing from the scope of the invention.

### Overview

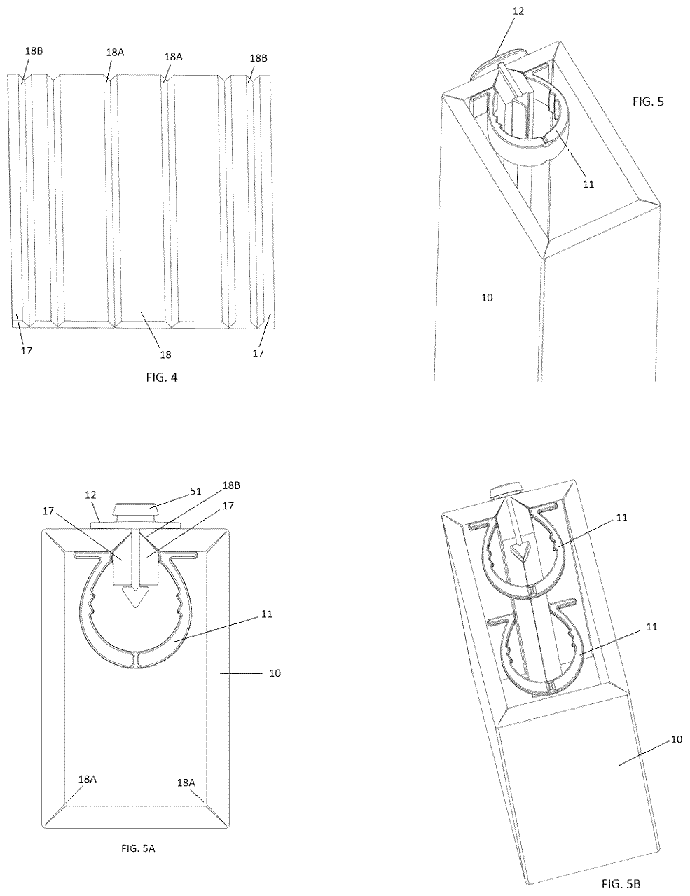

A sound absorbing beam product is assembled from mitre-grooved and folded material such as a needle punched PET material (e.g., 6 mm needle punched PET material) a portion of which is shown in FIG. 4. Needle-punched PET material is the most preferred option due to its combination of several advantages. It offers excellent sound absorption, making it ideal for acoustic applications. Its lightweight property allows easy handling and installation, while its durability provides long-term performance without compromising on structural integrity. Additionally, PET is a cost-effective material. Most importantly, its recyclability allows the entire beam, including its clips and connectors, to be repurposed without the need for disassembly, making it a sustainable and environmentally friendly choice. In some embodiments the beam product may be assembled from other suitable material or thermoplastic material that is capable of being recycled or upcycled, e.g., natural fibre-based material.

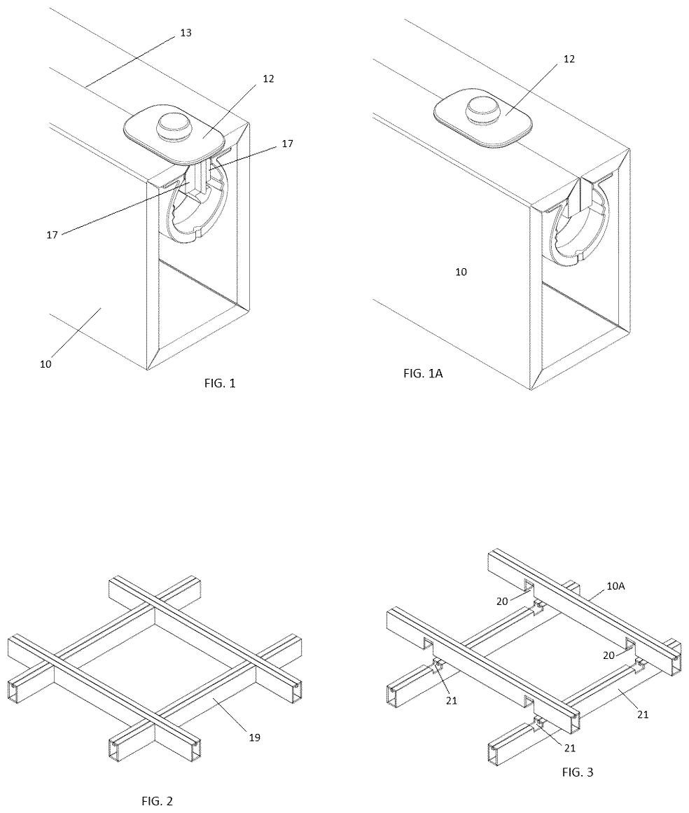

The assembled hollow beam is shown in FIGS. 1 and 7 (the latter having its end cap 14) in place). The beam (10) is held together by at least one, but most preferably, plurality of clips 11 and connectors 52A or 52B made of PET, so that the entire beam with its clips 11 and connectors 52A, 52B can be recycled without the need for disassembly or removal of component parts. This hollow beam product is described in more detail in Example 1.

FIG. 2 shows another sound absorbing product made from needle punched PET in the form of a grid made up of interlocking hollow rectangular or square section beams also held together by PET clips and connectors. Further details of this are described in Example 2.

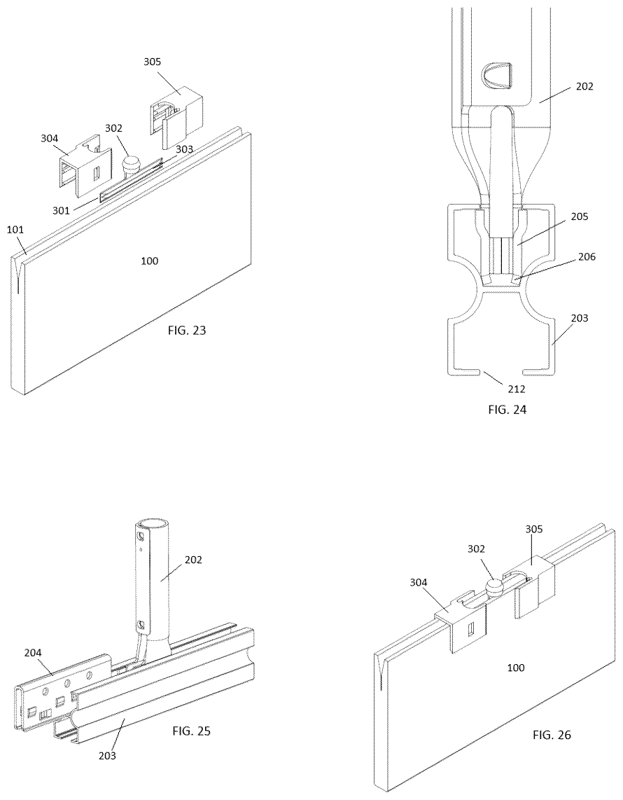

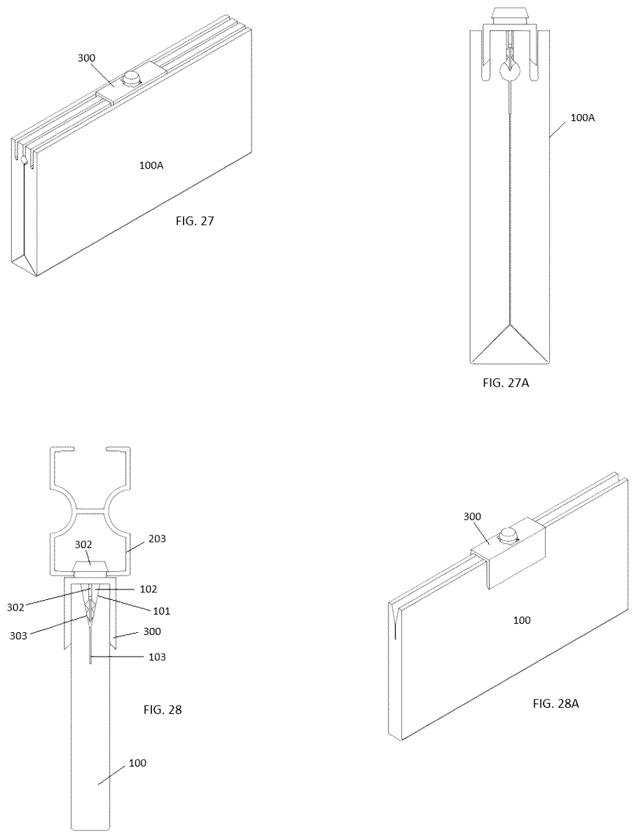

Another acoustic element consists of a series of fins made of needle punched PET as shown, for example, in FIGS. 23 and 26-28.

By designing the sound absorbing products to make use of needle punched PET, whether as fins or as folded or interlocking needle punched PET sheets or boards without using adhesives or fasteners of metal or other materials and instead relying on plastic components made of PET (either recycled or virgin PET) the entire sound absorbing products can be recycled without needing to separate out foreign (non-PET) components.

### Example 1

FIG. 1 shows the beam 10 in the form of a hollow rectangular beam folded, most preferably from a needle punched PET panel (designated 18 in FIG. 4), with outer ends of the panel folded to form a groove along the length of the top face of the beam 10. This panel 18 has mitred grooves 18A to assist in folding it into a beam. The folds at each end allow for the internal shapes shown in FIG. 5A (end elevation of the folded rectangular beam).

The folded beam 10 of FIG. 1 has a longitudinal groove 13 where the two outer edges of the previously flat panel are folded together. The interior of the groove is defined by the return 17/fold 17/flange 17. This return 17 is held in place by PET spring clips 11 (best seen in Fure 6 and 6A). These injection moulded PET clips can have wings 32 on either side of a pair of barbs 30. The interior of each clip 11 can have one or more dispensing barbs 31. The clips 11 are resilient so that they can be pushed apart by the insertion of an arrowhead 52 (of a connector) but then spring back into place.

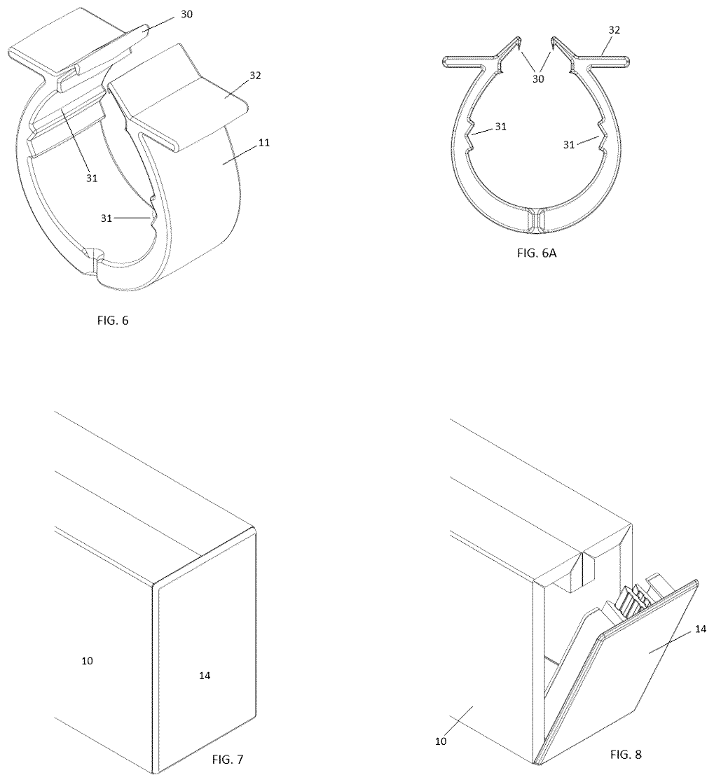

Thus, the clip 11 which is an injection-moulded PET component designed to secure a connector within a folded beam 10. The clip 11 in this example has a substantially circular or semi-circular body with a resilient structure that allows for controlled expansion and contraction. As shown in FIGS. 6 and 6A, the clip 11 may include a pair of outwardly extending wings 32, positioned on opposite sides of the clip 11. These wings can provide additional stability and engagement within the beam structure, preventing unintended displacement. Located adjacent to the wings 32 are a pair of barbs 30, which allow secure retention within the folded beam when inserted. The barbs 30 may be angled or shaped to resist removal forces, thereby improving the structural integrity of the assembly. The connector may be made out of the same material as the clip 10.

The inner surface of the clip 11 may be provided with additional dispensing barbs 31 which are internal barbs of the clip. The clip 11 is designed to be resilient, so that upon the insertion of a retention portion (e.g., an arrowhead 52 of the connector), the clip can temporarily expand to accommodate the insertion but subsequently springs back into place, effectively locking the retention portion (e.g. arrowhead 52 of the connector) within the beam. The retention portion may also be referred to as a holding portion or a securing portion.

As seen in FIG. 5, when the clip 11 is inserted into the beam 10, it interacts with other structural components, such as the connector 52A or 52B for a firm and stable connection within the assembly. The resilient nature/property of the clip 11 allows repeated engagement and disengagement.

Preferably there is a short return 17 inside the beam to allow clips to be placed around the return to clip or secure the two sides of the return 17 together. This configuration prevents the beam from unfolding and maintaining a secure connection. By providing a gripping edge of the clips 11, the return can cold the folded sections of the beam tightly.

The upper groove 13 also allows for connectors 50A or 50B to be pushed or slid into the groove 13 to allow connection to a suspension system or for direct fixing to a wall or ceiling. The retention portion, in this example, the arrowhead 52 of each connector 50A or 50B is held in place by the barbs 30 of the clips 11 placed along the length of the hollow beam 10. Typically, these clips 11 can be located spaced apart from each other (e.g. about 200 mm apart) along the length of each beam. In some examples, only one clip or connector may be used, although, it is most preferred that the plurality of connectors and clips are used for adequate support and stability.

The connector 50A shown in FIGS. 11 and 11A has coupling member 51, shaped as a protruding mushroom, designed to sit above the beam and engage with a suitable suspension system. The connector 50A may include a connector plate 12 which is configured to abut the beam from above as shown in FIG. 1. The coupling member 51 may be integrally formed with the connector plate 12. In other words, the coupling member 51 may be manufactured as a single piece with the coupling plate.

Preferably the coupling member 51 is shaped to clip into a rail 203 providing secure engagement with the suspension system. The lower portion, which in this example is an arrowhead portion 52 (by having an arrowhead like shape) is designed to be inserted into and locked within the folded beam.

The length of the beam or each beam (if there are multiple) may be dependent on the width of the flat panel form which it is formed. This length may typically be 1200 mm. Consequently, if longer beam lengths are required then beams can be joined end to end. Preferably joiners (not shown) may be used for joining two beams together. The joiners can be similar to the endcaps but will be internal to join two beam lengths together in-line. Preferably they have two sided barbs for each joined section.

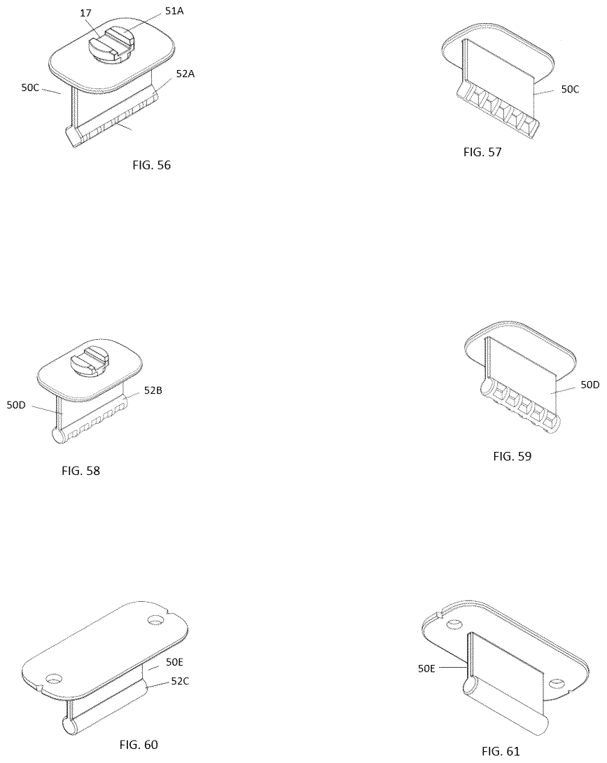

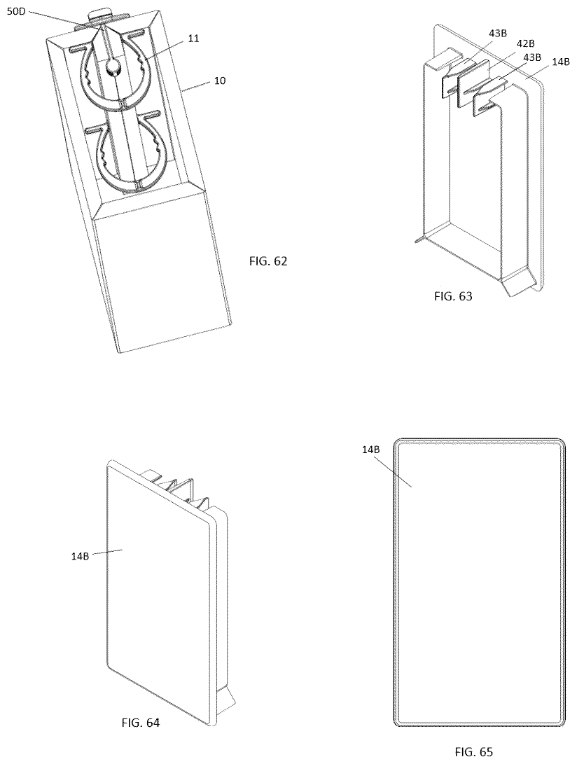

The retention portion 52 of the connector 50A described above need not necessarily be an arrowhead shape, as various other configurations may be used to achieve secure engagement within the beam. Some non-limiting examples of alternative securing portion geometries are illustrated in FIGS. 56 and 58. In these embodiments, the retaining/securing portions 52A and 52B adopt different profiles while still fulfilling the same function of engaging within the beam structure.

In FIG. 56, the retention portion 52A has a diamond-shaped profile, which provides an engagement surface for secure retention within the beam. This angular geometry can help distribute forces evenly and provide stability once inserted. In contrast, FIG. 58 features a cylindrical securing portion 52B offering an alternative retention/securing/holding mechanism.

As it can be seen from the embodiments of FIGS. 56 and 58, the retention portions may have recesses, such as recess 13 shown in FIG. 56. Such recesses can aid in the cooling process during the manufacturing of such PET components by increasing surface area and reducing residual heat build-up.

As shown, the coupling members of the embodiments of the connectors of FIGS. 56 and 58 may also be different from that of the coupling member 51 of connector 50A. For example, the coupling member 51A of connector 50C may also have recess 17 which can aid in cooling process during the manufacturing. The coupling member may be of many other suitable shapes than what is depicted in the drawings.

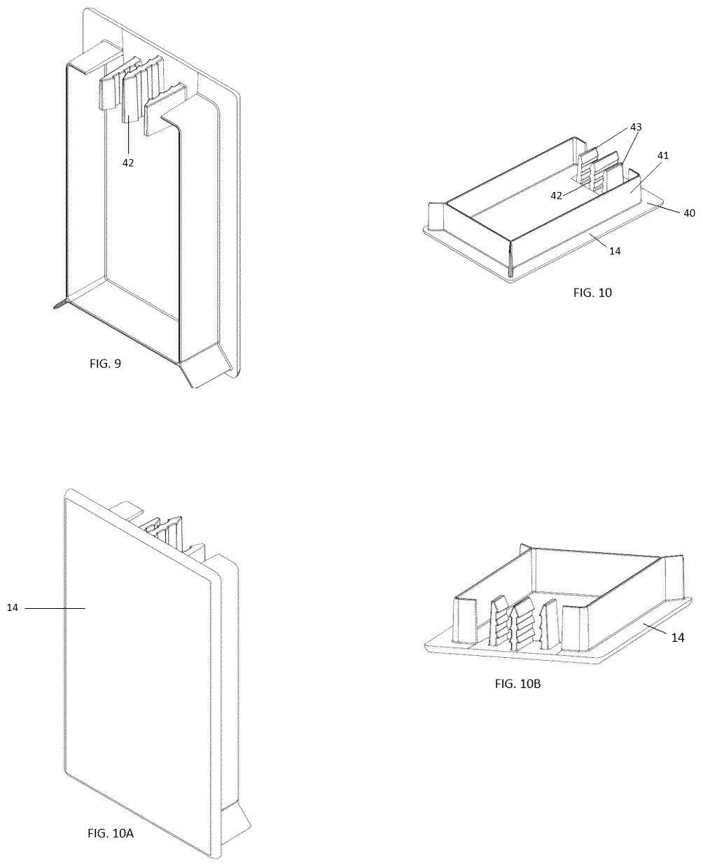

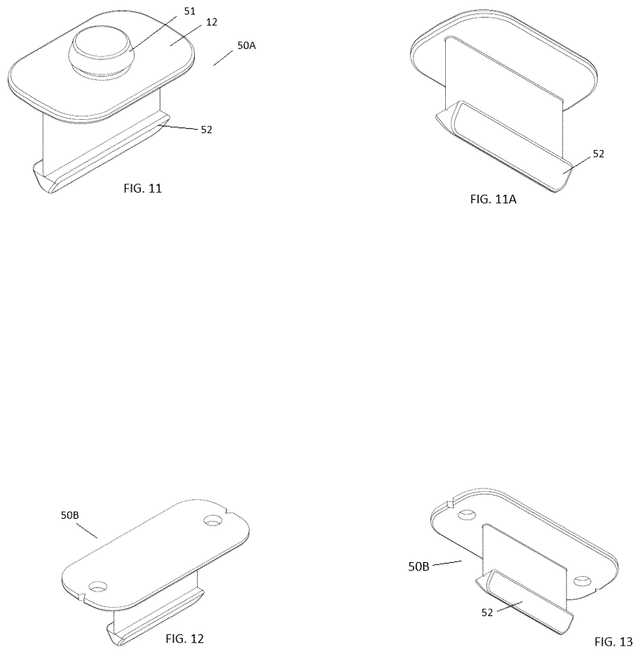

FIG. 12 is a modified connector (50B) designed to fit directly onto walls or ceilings. Unlike the connector 50A of FIG. 11, this connector (50B) omits the coupling member and instead comprises a flat or substantially flat mounting plate with apertures for fixing screws or the like.

FIG. 13 is an underside perspective view of the connector 50B of FIG. 12. The mounting plate includes at least one fastening aperture to accommodate screws, bolts, or other suitable securing elements. The lower portion of the connector 50B includes a retention portion similar to that the connector 50A of FIG. 11, designed for insertion and engagement with the folded beam. The omission of the coupling member allows the connector 50B to be affixed flush against flat or substantially flat surface while still providing a reliable insertion and engagement with the folded beam with its retention portion 52.

FIGS. 60 shows alternative variations of the connector 50E that is designed to fit directly onto walls or ceilings. The connector 50E of FIGS. 60 and 61 are similar in most aspects to the connector 50B and the differences can be identified by comparing FIGS. 11 and 12 with FIGS. 60 and 61. The difference lies in the retention portion 52C which is cylindrical as opposed to being formed as arrowhead. Many other suitable shapes are possible for the retention portion including the shapes as described with reference to FIGS. 56 and 58. Similarly, the retaining/retention portion of the connectors 50C and 50D of FIGS. 56 to 58 may also have similar shape as the retaining feature of the connector 50D.

FIG. 66 is an end perspective view of the beam of FIG. 1, with the end cap removed, showing how the folded needle punched PET material is held together by clip of FIG. 6 and connector of FIG. 58. FIG. 67 is an end view of the beam of FIG. 1, with the end cap removed, showing how the folded needle punched PET material is held together by clip of FIG. 6 and connector of FIG. 58. FIG. 68 is an underside perspective view of the beam of FIG. 1, with the end cap removed, showing how the folded needle punched PET material is held together by clip of FIG. 6 and connector of FIG. 58.

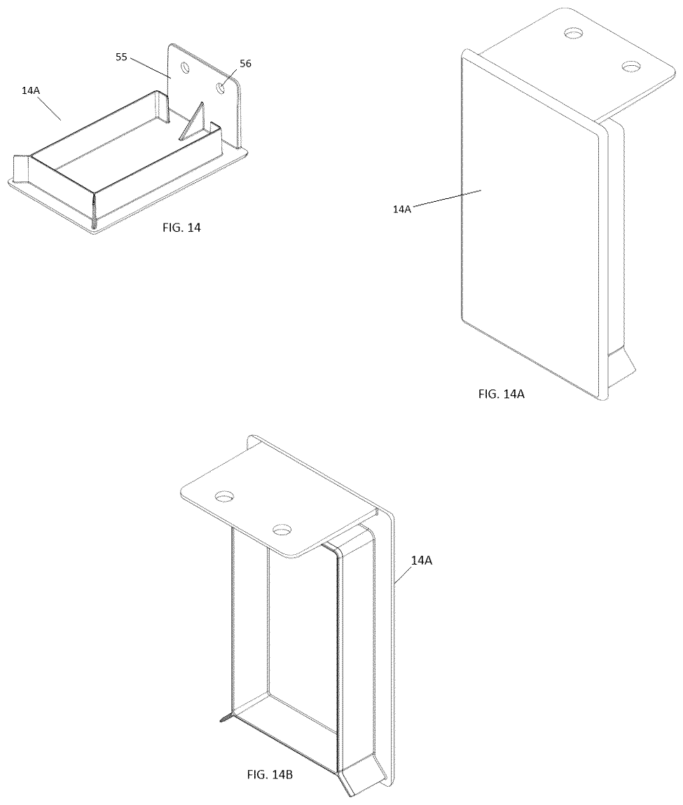

FIG. 14 is an example of the end cap in the form of a wall mount 14A that is designed to support the end of a beam such as beam 10 to prevent the beam 10 from sliding. The wall mount 14A provides a stable anchoring point by securing the beam against a fixed structure, such as a wall or ceiling.

The wall mount 14A in this example includes at least one fastening aperture 56 positioned on the mounting plate or wall plate 55 that is located vertically from the rest of the portions of the wall mount 14A, allowing for attachment using screws, bolts, or other fastening elements.

As shown in FIGS. 14A and 14B, the wall mount 14A features an L-shaped or bracketed structure, configured to receive and support the beam's end. This configuration can allow a secure fit while preventing lateral movement of the beam 10 once installed.

End caps 14 are configured to be inserted at each end of the beam 10 to hide/conceal the interior configuration while providing a finished appearance. A suitable end cap is shown in an example of FIGS. 7 to 10 and 10A-10B. The end cap 14 (also may be referred to as endcap 14) has an end wall 40 that corresponds to the dimensions (cross-sectional dimensions) of the beam 10 for a precise fit. The end cap further includes interior wall 41, which provide additional structural support and aid in positioning the end cap securely to the beam 10.

To allow secure attachment, end cap 14 is provided with multiple tongues 42, 43 which extends inwardly from the end cap to engage with the return 17 (short return 17) of the beam 10. The tongues 42, 43 are arranged is a spaced configuration, as shown in FIG. 10. The tongues 42, 43 may be formed as barbed portions or barbs, allowing them to securely grip the return 17 upon insertion and resist removal forces.

Alternatively, if the beams are to be attached to a wall, ceiling or other structural surfaces, a modified end cap variant/wall mount (14A in FIG. 14) can be utilised. This variant includes extended wall plate 55, for fastening to a fixed surface via apertures 56. This allows beams to be mounted horizontally or vertically, or at an angle or a selected angle to the horizontal, depending on the desired visual effect. When beams need to be replaced or recycled, they can be detached from the secured end caps, and the end caps either be re-used with new beams or removed. The screws may be discarded.

Multiple sizes (e.g. 3 standard sizes) of beams 10 may be produced. A typical size may include 50 mm width with height variations of 50 mm, 80 mm and 130 mm (these sizes may be adjusted by a few mm). The final sizes may be designed to ensure that there is minimal material wastage in a standard 6 mm needle punched PET panel/sheet. Each size variation may have a corresponding end cap 14 specifically designed for its dimensions. Additionally, joiners may be provided to allow the connection of multiple beam sections for longer installations.

This sound absorbing product may be wholly produced from PET material. The base material of the sound absorbing product is more preferably PET and the clips and endcaps is most preferably moulded from pellets recycled from PET waste. The connector is also more preferably moulded from pellets recycled from PET waste. An aspect of the sound absorbing product or the acoustic product of the present invention is the ability to fully recycle it at the end of its life without the disassembly of sub-components.

It is important that at the end of life, a complete beam is able to go into a chipper to produce uncontaminated PET material for recycling.

In an embodiment of the present invention, the beam is held together internally with (preferably recycled) clips 11 that are PET clips as shown in FIG. 1. These allow a connector to be placed or slide unimpeded across the entire length of the beam (excluding where the endcaps are installed). The connectors 50A, 50B have retention portion (e.g. an arrowhead portion) that can be pushed into the top. The variants of the connector and endcap can allow the beam to be attached to a wall.

One such assembled beam is shown in FIG. 7 with the endcaps 14 in place (to hide the internal clips).

Thus, it can be appreciated that FIGS. 8 to 10 show the construction of end caps according to one embodiment of the present invention. As shown, an endcap 14 may comprise barbed portions 42,43 that are designed to lock against the end of the short internal return (fold or flanges) associated with or of the longitudinal beam.

In FIG. 8 the endcap is shown partially removed to illustrate the barbs or barb portions 42, 43 which can grip the inside of the folded beam. FIG. 9 is an interior in view of the endcap of FIG. 7 showing the location for the barbs or barb portions 42, 43. Similarly FIG. 10 is in another view of showing details of the endcap 14 and its barbs or barb portions 42, 43.

The beam(s) 10 can be suspended from the structure (or from existing suspended ceilings) or can be wall mounted as required. If they are suspended from above then connectors 50A, 50B can be inserted in the upper groove 13.

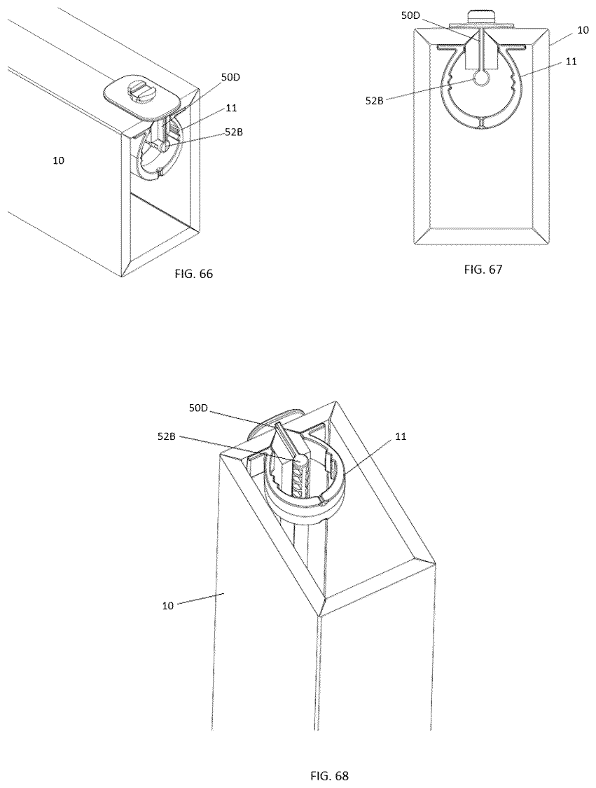

FIG. 63 is an interior view of an end cap 14B according to one other embodiment of the present invention. The end cap 14B can be inserted into the end of a folded beam that is the beam of FIG. 1. FIG. 64 is a perspective view of the endcap 14B of FIG. 63, showing the exterior and top of the endcap of FIG. 63. FIG. 65 is the exterior view of the endcap 14B of FIG. 63. The end cap may be made solely of PET material. In some embodiments, the end cap may be made from the same material as the clip and/or connector.

The endcap 14B is similar in most aspects to the endcap 14 and therefore need not be described again and the differences can be identified by comparing the figures relating to these two different types of endcaps. The difference lies in the shape of barbs 42B, 43B as compared to the barbs 42, 43. Many other suitable shapes are possible for the barbs 42, 43, 42B, 43B.

Some of the key Innovations or features of construction of the acoustic components may include the following:
Recycling—The acoustic architectural products and mounting subcomponents can all be made from 100% needle punched PET panel or recycled PET. This makes recycling at end of life very straightforward as no disassembly of the acoustic products will be required.
Construction—A rectangular profile is folded from material such as needle punced PET material or panel, most preferably 6 mm needle punched PET material or panel (e.g. Cube™ material of Autex Acoustics). The mitred groove on such material or panel removes material at the corners for folding. The internal folds at top centre are clipped together from the inside. The clips are most preferably made from 100% recycled PET material. During assembly, the needle punched PET panel or recycled PET material is folded and the clips installed inside at set distances apart.
The clips 11 which are apparent in the final product have a number of features that allow for a robust product. The long thin barbs 30 at the end are configured to hook into the softer mitre grooves (the outside skin is harder to grab a hold of) and this prevents the clips 11 coming off with impact. They are slender to not disturb the folded corners. There may be a dispensing notch feature inside each clip which is used to dispense them. On the top of the clip on each side is a shoulder feature or wings 32 which has two functions: to hold the top of the folded rectangle flat when lifted; and to allow a visual check of the position of any clip to ensure it is adequately installed. The clips 11 can also be dispensed wherever they are required—for the acoustic architectural products, a clip 11 can be dispensed proximal to any joining feature or groove. The clips 11 can also be distributed closer to hanging points if desired or close to the endcaps 14 to allow a tighter hold.
Adjustment—The clips 11 which may also be referred to as internal clips are constructed to allow adjustment of the connectors 52A, 52B (with the suspension system or wall) over the full length of the beam 10. This adjustment is simple and allows for fine tuning the position for assembly of the components.
Endcaps—These are designed to suit the internal top folds for connection. They have a triple barbed system (or double barbed if the internal barb is removed as a separate embodiment) which is inserted to the ends and clamps the 6 mm needle punched PET material or panel. Guides which fit into the bottom two mitres help prevent the rectangular section from going into a trapezoidal shape.
Joiners—These may be similar to the endcaps but configured to be internal to join two beam lengths together in-line. The joiners may have two-sided barb for each joined section.

### Example 2

In this example the hollow beams 10 as described in Example 1 can be assembled or connected together to form a grid 19 as shown in FIGS. 2 and 3.

This can be achieved by cutting notches or slots 20 in the underside of each beam in a first set of beams 10A (which serve as the upper beams, with their groves 13 facing upward). Similarly, notches or slots 21 may be cut into the upper side of each beam in a second set of 10B (which serve as lower beams), as shown in FIG. 3.

When assembling the grid, the notches or slots 20 in each upper beam may be aligned with the notches or slots 21 in each lower beam 10B. By pressing the upper beams 10A down into the notches or slots 21 of the lower beams 10B, the beams interlock, with the notches or slots 20 of the upper beams 10A engaging with the lower beams 10B (more specifically upper edges of the lower beams 10B) at their notches or slots 21, thereby forming a stable grid structure. In some examples, the interlocking connection may include a snap-fit arrangement, where complementary engagement features (e.g. notches or slots) on the beams create a secure and resilient fit, reducing movement and improving structural stability of the grid structure.

The resulting grid structure can be suspended using a suitable suspension system, using connectors such as connectors 50A having a coupling member 51 (e.g. a mushroom/dome shaped coupling member) that fits into the upper slots of both upper and lower beams 10A and 10B. While FIG. 3 shows an example with two upper beams 10A and two lower beams 10B, the grid may be expanded by adding more beams to both the upper and lower sets of beams as needed. Various other configurations can be created without the need for adhesives or metallic componentry or fasteners.

### Example 3

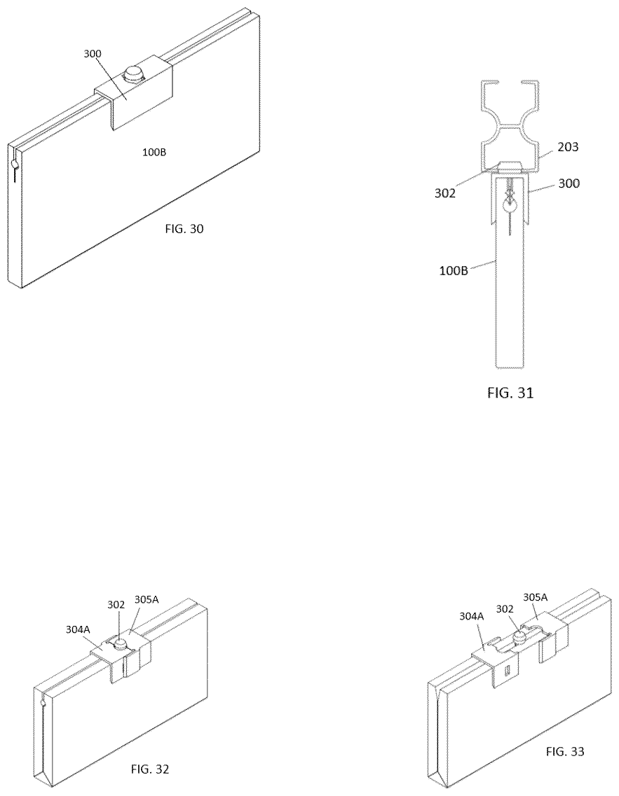

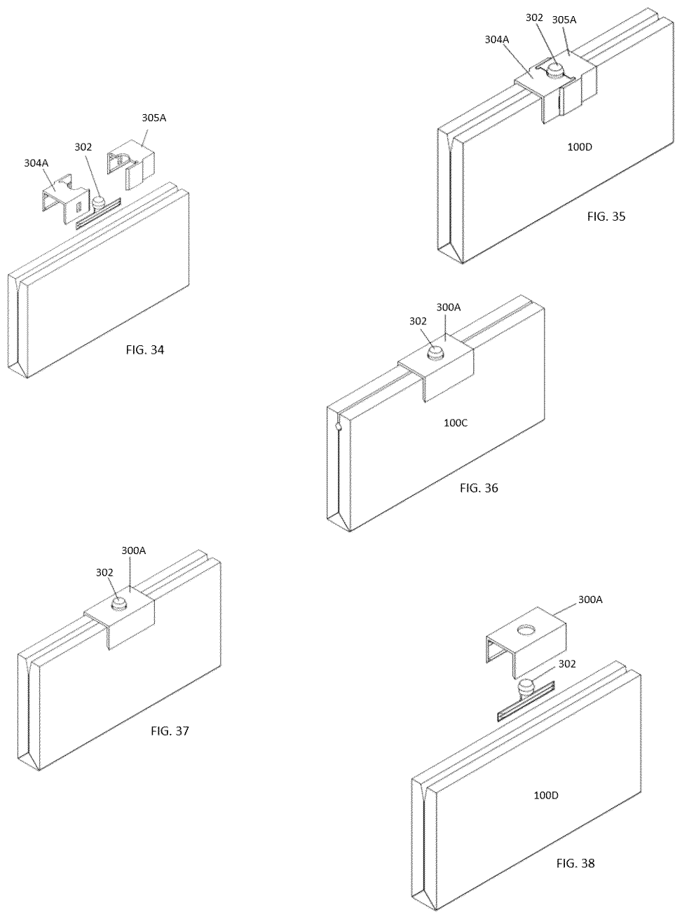

If desired the sound absorbers can be relatively thin fins formed of needle punched PET instead of the hollow beams shown, for example, in FIGS. 1-7. Examples of fin is shown in FIGS. 23-27, 27A, 28, 28A-28D, 29-45.

These figures depict multiple examples of fins with different groove profiles, showing variations in shape and configuration. The differences in groove profiles may contribute to aesthetic variations, acoustic performance, and structural compatibility.

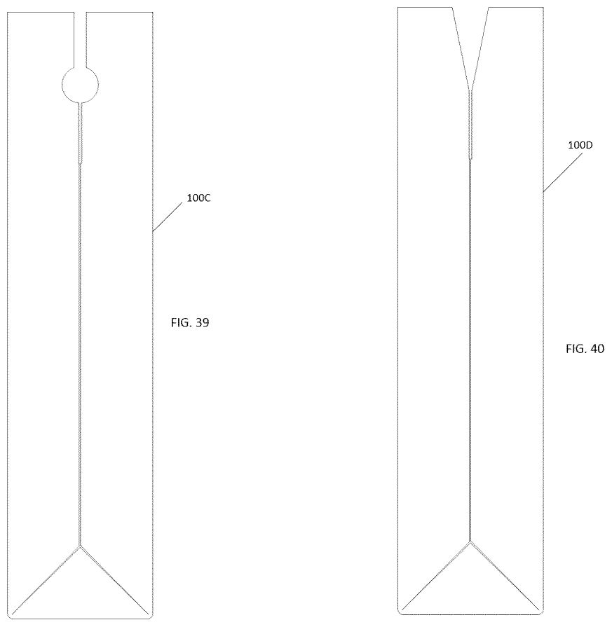

FIGS. 39 to 44 in particular show the closeup views of the groove profiles of the various examples of fins 100, 100A,100B, 100C, 100D, 100E. Other than the difference in the groove profiles the fins are essentially the same.

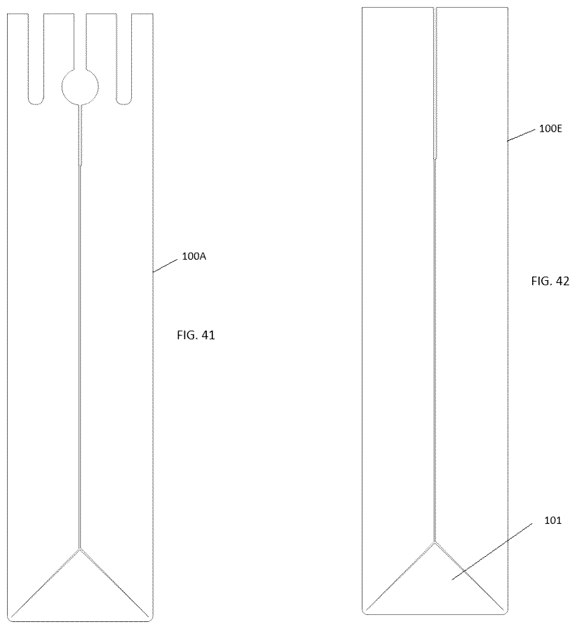

As these figures are largely self-explanatory, a detailed description of each variation is not necessary. However, in summary, FIGS. 39 to 44 show various fin profiles with distinct geometric features. As shown in FIG. 39, fin 100C has a centrally located narrow first vertical groove at the top which transitions to a circular aperture and then again to much narrower second vertical groove towards the bottom direction. As shown in FIG. 40, fin 100D features a V-shaped notch at the top, which transitions into a narrow vertical groove towards the bottom direction. As shown in FIG. 41, fin 100A includes multiple parallel rectangular grooves at the top, along with a centrally positioned groove that is similar to the groove of fin 100C. As shown in FIG. 42, fin 100E has a single, straight vertical groove extending from the top towards the bottom direction. As shown in FIG. 43, fin 100 displays a deep V-shaped notch at the top, leading into a narrow, straight groove running downward. As shown in FIG. 44, fin 100B features a long, straight vertical groove along the centre which transitions to a circular aperture and then again to much narrower second vertical groove running towards the bottom direction.

FIG. 45 illustrates the fin 100E of FIG. 42 in an unfolded condition, showing the internal fold configuration. The fin 100E includes a central fold line/fold section 101, with adjacent fold sections 101A and 101B, which define the angular formation when assembled. In this unfolded state, the fin presents a flat profile, allowing for efficient manufacturing and transport before being folded into its final shape. Fins in FIGS. 39 to 42 can have a similar configuration when unfolded, with corresponding fold sections forming their respective profiles. However, FIGS. 43 and 44 do not feature this foldable structure, as their grooves are cut directly into a single, flat panel without requiring folding to achieve their final shape.

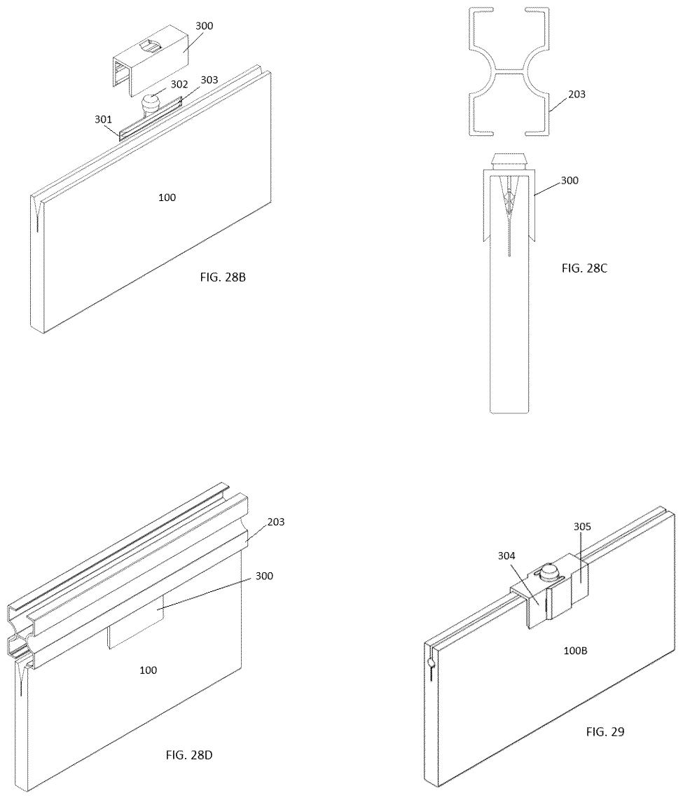

These fins can be typically 12 mm thick made up of two 6 mm needle punched PET panels secured together without adhesives, e.g. by needle punching or friction welding. A longitudinal groove can be formed along one edge of the fin, so that a suitable connector or PET connector can be inserted into the groove. Preferably the groove 101 is formed so that the upper part of the groove is Vee-shaped 102 above a narrow lower part 103 to allow a retaining feature such as the arrowhead of a connector of the type shown in FIG. 11 or 12 to be inserted into the groove 102 and held in place, as shown in the suspension system (described below) of FIG. 28. However, the groove can be of various different suitable shapes and configurations such as shown in the figures, which are self-explanatory.

The clip assemblies attached to the fins will be described with reference to the suspension system of Example 4.

Some of the key innovations or features of construction of the acoustic components may include the following:
Recycling—The acoustic architectural products and mounting subcomponents can all be made from 100% needle punched PET panel or recycled PET. This makes recycling at end of life very straightforward as no disassembly of the acoustic products will be required.
Construction—The fins can have grooves formed in their upper edges for reception of moulded PET clips, so the fins and clips can be recycled at the end of their life.
The clips which are apparent in the final product have a number of features that allow for a robust product. There have long thin barbs at the end which hook into the softer mitre grooves (the outside skin is harder to grab a hold of) and this prevents them coming off with impact. They are slender to not disturb the shape of the fins.

### Example 4—Suspension System

This invention relates to a modular ceiling suspension system particularly suited to the suspension of the acoustic products described above. But it can be used to suspend other products.

### Overview and Component Description

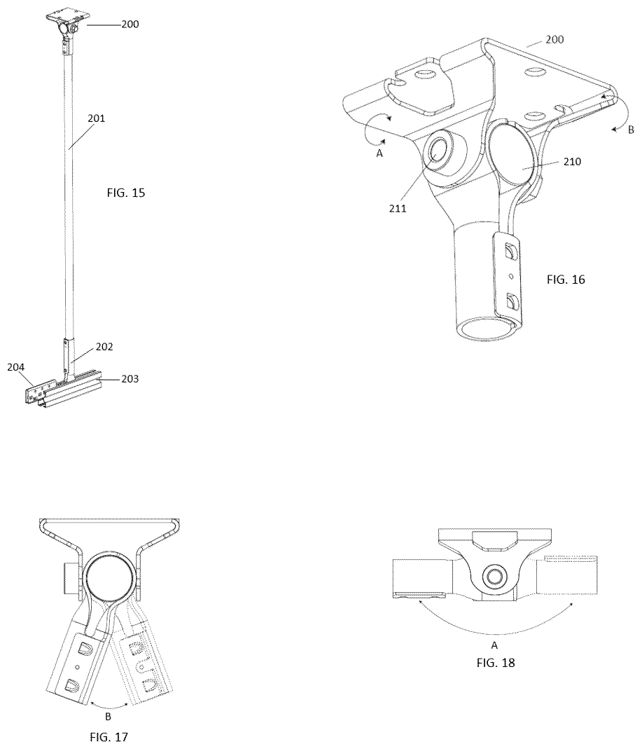

FIG. 15 shows a suspension system according to one embodiment of the present invention. This figure shows the assembly of the various suspension components, forming a system designed to suspend acoustic elements. Unlike the acoustic components in the above Examples 1 to 3, these suspension components are preferably made primarily of metal for structural support and durability.

The suspension system comprises a dropper bracket 200 which is shown in more detail in FIG. 16. The dropper bracket 200 is configured to be attached to a supporting structure, such as a ceiling or the underside of an overhead concrete floor. It comprises a dropper tube 201 extending downward from the dropper bracket 200. The dropper tube 201 can be of different lengths to accommodate the desired positioning of the acoustic element (for examples, the fin of FIG. 28 or any other fins described above or the grid of FIG. 2 or the beam of FIG. 1).

At a lower end of the dropper tube 201, a rail bracket 202 is provided, which supports a rail 203. The rail 203 serves as a mounting structure for an acoustic element (not shown in FIG. 15). To extend the length of the rail 203, additional rail sections can be connected using rail joiners 204 thereby allowing a modular and adaptable configuration.

The dropper bracket 200 comprises a central dowel component 210 (pivoting component 210) and a main bolt 211, which allow the dropper tube 201 to pivot and hang vertically even if the mounting surface is uneven, such as on a pitched roof. The pivoting mechanism can operate along two axes, namely a major axis A and minor axis B to allow pivoting in two directions. The major axis A has a large degree of rotation (up to 180 degrees as shown in FIG. 18) whereas the minor axis has a limited movement due to geometry constraints, preferably substantially 15 degrees in either direction as shown in FIG. 17. Such duel-axis pivoting allows dropper tube 201 to hang plumb under its own weight, with its centre of mass acting through the intersection of these two axes. Once the dropper tube is correctly aligned, the main bolt 211 can be tightened to lock the system in place, securing the assembly and providing the additional bracing support. The dropper bracket 200 has a large footprint to improve stability particularly in seismic-prone regions.

Additionally, as part of the sheet metal forming process, “D” features may be integrated into the bracket design. These D-shaped structural elements may lock the collar together without additional fixings or fasteners, improving strength and minimise the number of required fasteners or fixings. This design can eliminate the need for more than one fastener (e.g., more than one on each side) to hold the bracket together.

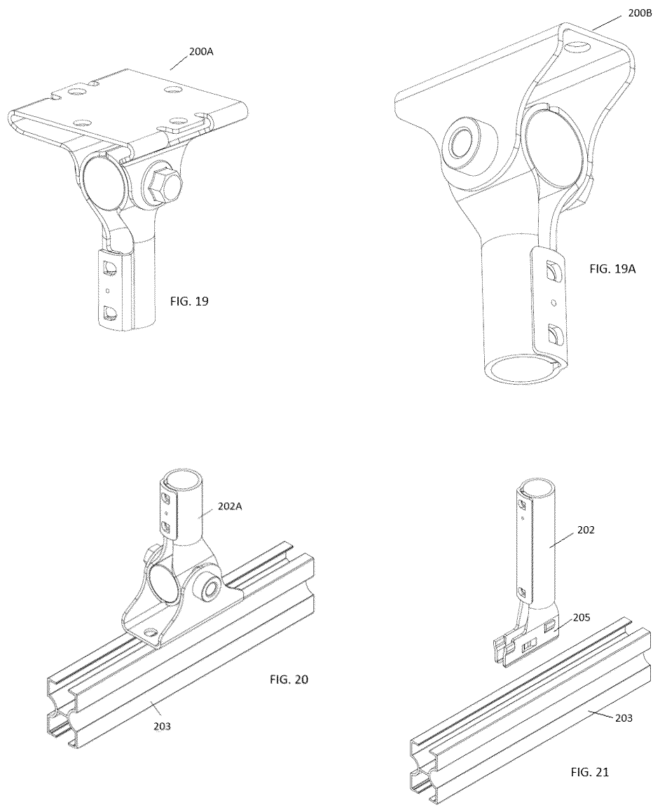

An example of a more simplified version of the dropper bracket is shown in FIG. 19. This alternative bracket design has a smaller footprint and is easier to manufacture. It is particularly suitable for regions with lower seismic activity, where extensive bracing is not required. This bracket 200A can also be used in special installations where complex angles are necessary, such as when mounting on sloped ceilings. —It maybe fastened to the rail and used to make complex angles. This may be where a sloped ceiling is required for instance.

The dropper bracket 200B of FIG. 19A is similar to the dropper bracket 200A of FIG. 19, with differences that can be identified by comparing FIGS. 19 and 19A. Notably, the top portion of bracket 200B, which is configured to be mounted to a structure such as a ceiling, is smaller compared to that of bracket 200A.

In some embodiments, the bracket 200, 200A, 200B may fastened directly to the rail 203.

### Dropper Tube

The dropper tube 201 is most preferably made from standard steel tubing and may provide vertical support within the suspension system. It may be powder-coated black to match other suspension components and to enhance corrosion resistance and durability. The dropper tube may be available in different lengths to accommodate various installation requirements, allowing adjustment of the suspended acoustic element's position.

The dropper tube 201 may have a hollow cross-section, which may reduce weight while maintaining structural integrity. Its diameter and wall thickness may be selected to allow sufficient load-bearing capacity while remaining compatible with the dropper bracket 200, 200A, 200B and rail bracket 202, 202A. The tube may be designed to allow for secure fastening at both ends while maintaining alignment and stability within the system.

### Rail Bracket and Rail

FIG. 20 shows a close up of the rail 203 and rail bracket 202A according to one example of the present invention.

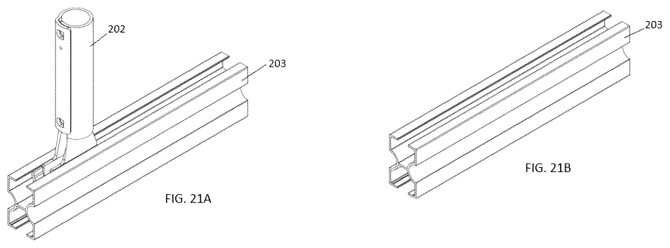

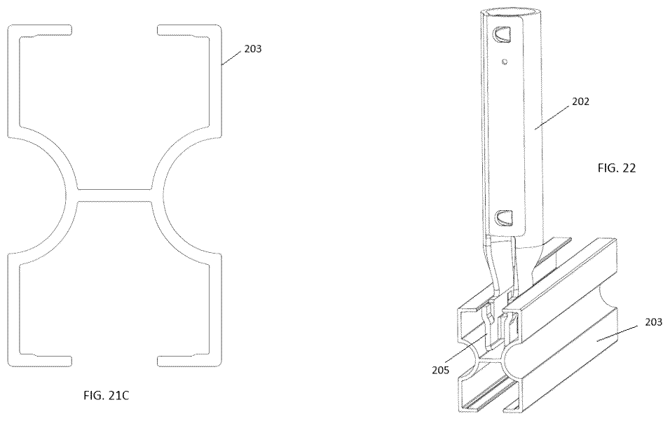

The rail bracket 202 is designed to engage with (into) the rail 203 without the need for tools. At least a portion of the rail may be manually inserted into the portion of the rail bracket, or vice versa. The connection may be configured an affirmative clipping sound indicating secure engagement. The engagement mechanism may rely on some flexibility in both the rail 203 and the clips (not shown in FIG. 20) of the rail bracket to allow a secure snap-fit connection. The base of the rail bracket may incorporate sheet metal features so that the clips remain properly spaced apart and engaged with the rail. The clips and the clipping arrangement may be similar to the clips 205 shown in the example of FIG. 21.

The rail bracket 202A may be connected to the dropper tube 201, and its attachment mechanism may be similar to that of the dropper bracket 200A. However, the tubular section of the rail bracket 202 may be longer to allow for fine tuning of the vertical position. This adjustment capability allows more approximate cutting of the dropper tubes, reducing precision requirements and thereby accelerating assembly. The height of the rail bracket may be adjusted to a laser reference line during installation, a common practice in suspended ceilings systems. Additional reference, such as notches, marks or edges may be included to assist with alignment. The rail bracket 202A may have a long side and a short side that connect to the rail 203. This configuration is based on manufacturing constraints, particularly the way the rail bracket 202A is formed from a sheet steel. The asymmetry in the rail bracket 202A design allows for efficient fabrication, thereby enabling proper material usage while maintaining the necessary structural integrity for secure attachment to the rail 203.

The rail 203 is configured to receive both the rail bracket (mounted on top) and connectors (positioned underneath). The rail is symmetric about two planes, simplifying installation and orientation. The semi-circular profiles on the sides of the rail provide a lead-in feature, for insertion of components such as the rail bracket and rail joiner(s) 204, preventing misalignment and jamming. These side profiles also contribute to material efficiency and manufacturing simplicity while giving the rail a distinctive shape. Based on its geometry and functional requirements, the rail 203 is preferably extruded from aluminium.

FIG. 21 shows a variant of the rail bracket 202A, that is disengaged from the rail 203. FIG. 21 shows the rail bracket in a pre-assembly position, showing how it aligns with the rail before engagement. The rail 203 may be a sheet metal rail.

Similar to the rail bracket 202A of FIG. 20, the rail bracket 202 is designed to engage with (into) the rail 203 without the need for tools. At least a portion of the rail 203 may be manually inserted into at least the portion of the bracket, or vice versa. The connection may be configured an affirmative clipping sound indicating secure engagement. The engagement mechanism may rely on some flexibility in both the rail 203 and the clips 205 of the rail bracket 202 to allow a secure snap-fit connection. The base of the rail bracket may incorporate sheet metal features so that the clips 205 remain properly spaced apart and engaged with the rail.

The rail bracket 202 in FIG. 21 is similar to the rail bracket 202A shown in FIG. 20.

The similarities between the rail bracket 202A of FIG. 20 and the rail bracket 202 of FIG. 21 need not be discussed again, and only the main differences will be discussed.

A main difference is that the rail bracket 202 in FIG. 21 does not include the central dowel or pivoting component that is present in FIG. 20. Instead, the tubular section of the rail bracket 202 extends directly down to the clipping mechanism 205, which is designed to engage with the rail 203. Due to the absence of the pivoting component/mechanism in the rail bracket 202, the rail bracket 202 cannot be pivoted as compared to the rail bracket 202A of FIG. 20. The rail bracket 202 may be configured to be positioned substantially 90 degrees to the rail 203 when coupled to the rail 203.

The engaged rail bracket of FIGS. 21 and 21A is shown in more detail in FIG. 22. FIGS. 21B and 21C show the rail and its profile in more detail.

FIG. 23 shows an example of an acoustic fin 100 and a disassembled clip assembly according to one example of the present invention. More specifically, FIG. 23 shows an exploded view of a slotted PET fin 100 and a clip assembly which can be supported by the rail 203 of FIGS. 20-23.

FIG. 24 shows the rail bracket 202 of FIG. 21 in an end elevation view that is inserted into the rail 203. It shows the structural alignment of the components and their engagement within the system.

The two planes of symmetry in the rail 203 are also shown in FIG. 24, which facilitate proper alignment during installation. Additionally, the lead-in profile 206 of the clips 205 is also shown. Such lead in profile 206 guides the rail bracket 202 into engagement with the rail 203.

The lead-in profile 206 helps prevent misalignment and ensures a smooth insertion process. The rail 203 also features an opening 212 for allowing for attachment of additional components or connectors within the system such as the coupling member 302 of the clip assembly of FIG. 23 or coupling member 51 as described above. This description with reference to FIG. 24 may also apply to the rail bracket 202 of FIG. 20, as both embodiments share similar engagement features with the rail 203.

It can be appreciated that the rail 203 of the present invention may have a symmetrical cross section having a pair of longitudinal grooves, one groove capable of retaining an inserted rail bracket and the other capable of supporting a head of a PET connector of an acoustic architectural product.

### Rail Joiner

An example of a rail Joiner 204 according to the present invention is shown in FIG. 25. It serves two primary functions: joining two ends of a rail 203 and allowing the rail 203 to be suspended using wires, similar to conventional suspended ceiling systems.

In some examples, the rail joiner 204 may be structurally similar to the rail bracket 202 or clips 205 of the rail bracket 205 and may be formed using sheet metal fabrication techniques.

In some examples, the rail joiner may feature a clipping mechanism designed to engage with the rail 203 securely, allowing a firm and stable connection between adjacent rail sections. The clipping mechanism may operate similarly to that of the rail bracket 202. It may use flexible retention features to allow the joiner to snap into place without the need for additional fasteners.

To join two rails, the rail joiner 204 may be inserted into the open ends of two adjacent rails. Each end of the joiner 204 may engage with the internal profiles of the respective rail sections, allowing it to bridge the connection between the two rails. The clipping features on both sides of the joiner may secure the rails in place, preventing movement or separation. The lead-in profile of the rail joiner may allow smooth insertion into both rail segments while maintaining alignment and reducing the risk of misalignment or jamming during assembly.

### Fin and Clips

The clip assembly, as shown in FIGS. 23 and 26, comprises three main structural components: retaining brackets 304 and 305, and a connector component, which includes the coupling member 302, engagement portion 303, and barbed feature 301. The connector component is more clearly shown in FIG. 55.

The retaining brackets 304 and 305 are configured to enclose and secure the fin 100 within the assembly, allowing a firm grip and for easy installation and removal. These brackets 304, 305 engage with the fin's top profile and provide lateral stability to the system.

The connector component serves as the primary attachment mechanism. It features a coupling member 302, which is designed for coupling with a suspension system (for example rail 203). The engagement portion 303 extends downward from the coupling portion and is shaped to interface with the fin. The barbed feature 301 is formed on the engagement portion 303 and that barbed features or barb(s) is/are configured to engage the fin by providing a mechanism that resists unintended disengagement.

When assembled, the clip assembly securely holds the fin in place while allowing proper alignment within the rail of the suspension system.

The retaining brackets 304 and 305 may be configured to lock together when fully assembled, as shown in FIG. 50, for a secure attachment of the fin. In contrast, the brackets may also remain unlocked or in a disengaged state, as shown for example in FIG. 26, allowing for adjustments or removal of the fin.

Instead of two retaining brackets, there may be only one retaining bracket 300 in the clip assembly as shown in FIG. 28A, for example. The clip assembly may be made solely from a PET material. The clip assembly may be made from the same material as clip and/or connector described in above.

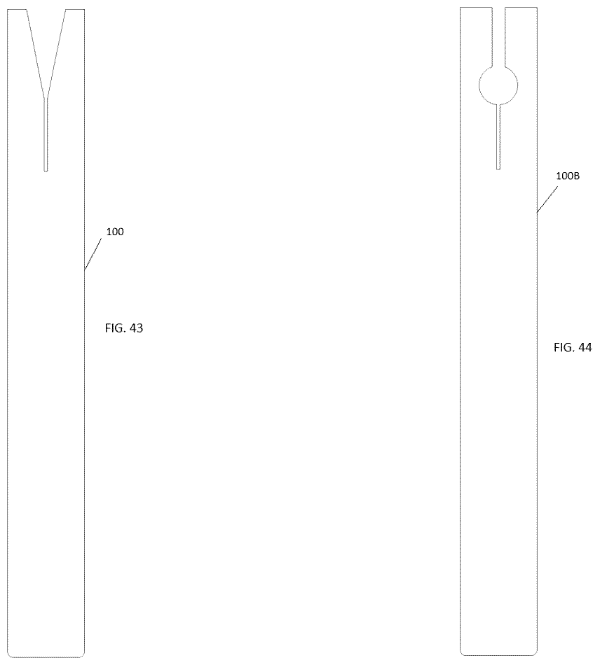

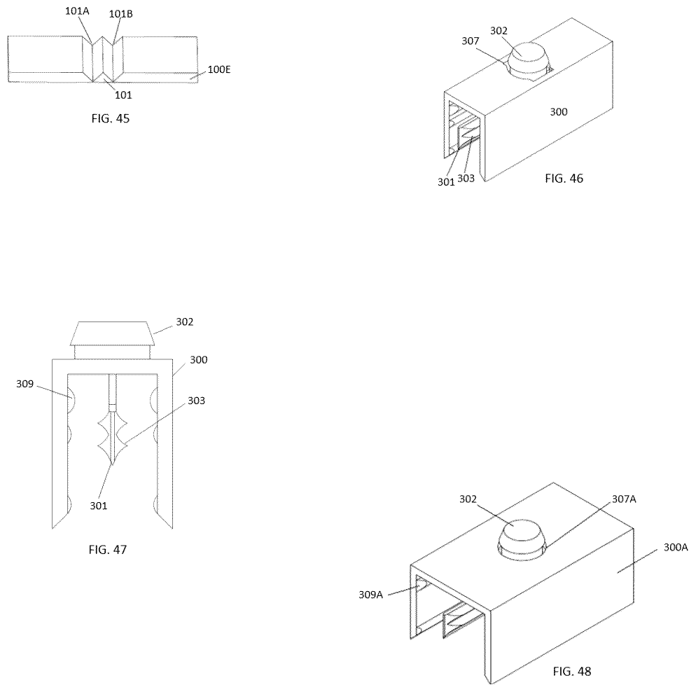

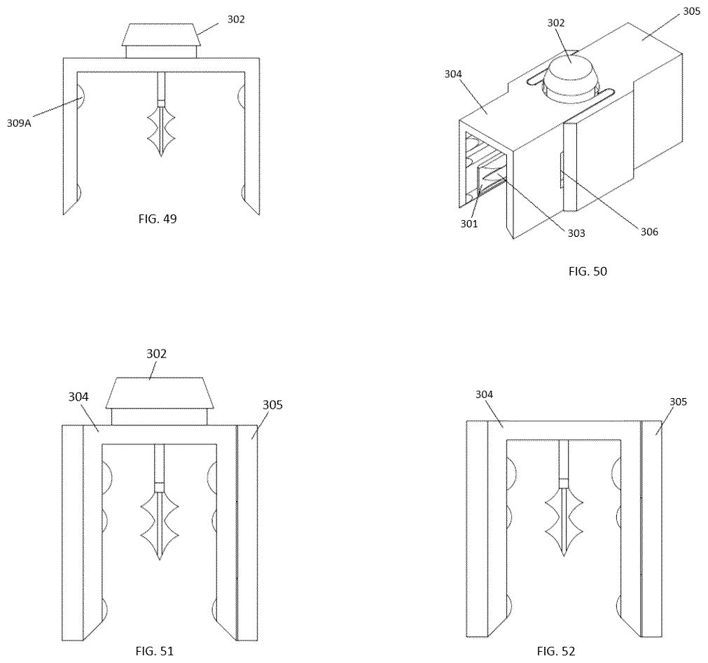

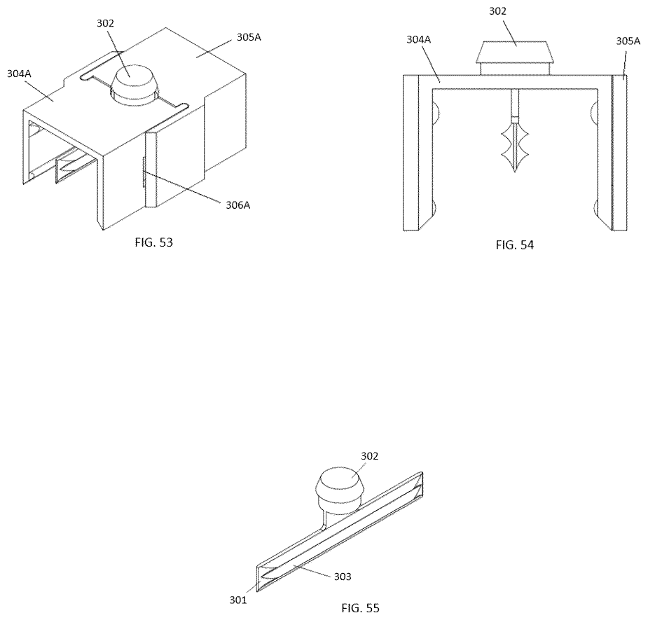

FIGS. 46 to 55 illustrate various examples of the clip assembly according to the present invention. The connector component remains identical across these embodiments, with differences primarily residing in the bracket configurations.

For example, the bracket of the clip assembly in FIG. 48 may be similar to bracket 300 of FIG. 46, except for the profile of aperture 307A, which is circular in FIG. 48. Additionally, the number of internal barbs 309A in the bracket of FIG. 48 differs from that of the bracket of the clip assembly of FIG. 46. The internal barbs. such as internal barbs 309, in the interior surface of the brackets improve engagement with the fin by providing additional grip. The width and/or height of the brackets 304A and 305B may also differ from that of the brackets 304, 305 to accommodate finds of various thickness, shape and configurations.

Similarly, differences between the clip assembly of FIG. 53 and the clip assembly of FIG. 50 can be identified by comparing the two figures. Specifically, in the clip assemblies of FIGS. 50 and 53, brackets 304 and 305 in FIG. 50 differ from brackets 305A and 305B in FIG. 53 in terms of internal barbs. The width and/or height of the bracket 300 may also differ from that of the brackets 300A to accommodate finds of various thickness, shape and configurations. Both brackets may include a catch or a detent 306 (in FIG. 50) and a catch of a detent 306A (in FIG. 53), which function to lock the brackets together in the assembled condition.

The brackets shown in FIGS. 46 to 55 are interchangeable and may be utilised across various embodiments of fins at the suit. Some of these variations are shown in the drawings which are self-explanatory and need not be described in further detail.

The clip assemblies may be made from PET material (whether virgin PET or recycled PET). Some of the key innovations or features of the suspension system may include the following:
Self-bracing—A major burden of existing systems is the requirement to brace them in earthquake prone areas. This is time consuming and inconvenient. Often a wire-hung supporting ceiling is assembled first and then the laborious process of diagonal bracing is added-this is usually ad-hoc, over-engineered to pass inspection and unsightly. Having a self-bracing system is very advantageous. The additional component cost is easily saved in labour, oversight and with a reduction of rework. The suspension system of the present invention allows a clean and aesthetically pleasing installation. The system can also be finished in various colours, a feature uncommon in existing systems.
Self-plumbing—The mechanics of the multi degree-of-freedom (MDOF) dropper bracket allows it to be installed to a ceiling with minimal fastenings. A rigid dropper tube hangs from this bracket and, due to its geometry, can automatically align to the plumb position. This self-plumbing capability is achieved because the centre of mass acts through the central axes of the swivel system even if the mating surface of the bracket is angled from plumb in both major and minor directions. The bracket may be designed so that both axes can be locked simultaneously by tightening of a single fastener. This fastener clamps the central swivel from both sides, securing the dropper tube position. Importantly, the fastener does not induce rotation in the hanging dropper tube due to tightening friction, as the main bracket wraps around the central swivel, preventing unintended movement. As a result, the system can be installed and tightened without requiring individual levelling of each dropper, significantly simplifying the installation process. Additionally, the tightening of the fastener process is required to create the sideways bracing action.
Simple assembly—The system is designed with ease of installation, so that assembly is straightforward and efficient. Components are designed to require minimal number of fastenings, reducing installation time and complexity. The need for additional bracing steps is eliminated. Components such as the rail bracket, are designed to clip into place without the use of fasteners all together allowing for secure and tool-free assembly. The design also allows long rail lengths to be assembled easily, without requiring the installer to hold additional tools or power equipment.
Sheetmetal design—Use of the sheet metal design allows for precise vertical adjustments, particularly on longer rail brackets. This allows installers to fine-tune the positioning of components during assembly, thereby allowing proper alignment. Additionally, pilot screw holes may be integrated into the design to guide fasteners into correct locations, allowing accurate and secure attachment while minimising installation errors.
Subtle features—In some examples, specific levelling features may be added (e.g., to the parts) to aid assembly. These features could include laser levelling lines stamped in, notched or laser marked to assist with precise height adjustment before parts/components such as rail bracket, are locked in place with a fastener.
Extrusion profile—The extrusion profile of the system and its parts may be symmetrical, allowing it to be installed in either orientation, which helps avoid confusion onsite and prevent errors and simplify on-site installation. This design allows various brackets, such as the rail bracket which can be securely clipped into place without additional fasteners. The long side profile may feature a semi-circular shape to vertically guide the brackets into place during assembly—and it may optimise material usage by integrating functional into the extrusion or by combining features.

From the above, it can be appreciated that in one embodiment the present invention may reside in the suspension system of they present invention is suitable for suspending acoustic elements from a structure (e.g. an overhead structure) without the need for additional bracing comprising one or more dropper brackets. The dropper bracket or each of the dropper brackets may be capable of being connected to the structure over and connectable to a dropper tube. The dropper tube may be connectable to a rail bracket which in turn can support a rail which is connectable to and can support a PET connector of an acoustic architectural product.

The dropper bracket or each dropper bracket may have a swivel connection between its mounting and a socket adapted to receive a dropper tube to provide at least one degree of freedom of movement of the socket relative to the mounting.

The dropper bracket or each of the dropper bracket may allow (e.g., may have a universal joint allowing) two degrees of freedom of movement of the socket relative to the mounting.

### Advantages of the Acoustic Elements and Their PET Clips

Some of the non-limiting advantages include:
The methods of designing acoustic elements such as PET acoustic elements and fixing of such acoustic elements to a substrate as described allows for recycling by using fixing components of the same plastic as that of the acoustic elements thereby avoiding the need to separate the acoustic elements and the fixing components during recycling.
No metal reinforcing is needed in the construction of the acoustic elements so that the acoustic elements can lawfully be recycled without the need for disassembly.
No glue is used on the acoustic elements so that the acoustic elements can lawfully be recycled.
Ease of fixing the acoustic element, such as a PET acoustic element, to a wall or ceiling or other building structure.
A stronger suspended ceiling system which does not require diagonal bracing.
The fins can be made from profiles cut from sheets of needle punched PET with a selection of thicknesses available.
The folded sheets of needle punched PET can be further refined with notched cuts so that a grid pattern is achieved.
The depth of each fin can be changed by changing the cutting profile. The top of the fins can be cut straight for engagement with the suspension system. The bottom (and possibly the side) edges may be cut straight and rectangular in a standard configuration or they can be cut tapered, on an angle or with complex curves.
The fins and their connectors may be wholly produced from PET material. The base material of needle punched PET panel is PET and the clips and endcaps may be moulded from pellets recycled from needle punched PET panel waste. The product is able to fully recycle at the end of its life without the disassembly of sub-components. A complete fin at the end of life is capable of being directly processed in a chipper to produce uncontaminated PET material for recycling.
The fins themselves have no additional parts. Connectors are added for assembly to the suspension system.
Recycling—The acoustic fins and beams and mounting subcomponents are most preferably all 100% virgin or recycled needle punched PET. This makes recycling at end of life very straightforward as no disassembly of the acoustic treatments will be required.
Construction—To facilitate installation of the connector a simple slit, v-groove or complex shape is cut into the top edge of each fin across its entire length. Either sharpened blades or heated profiles can be used to cut these shapes—sharpened blades are preferred as they are a simpler means of producing the geometry required. This enables complexity to be transferred to the connectors themselves which will be injection moulded—this will allow for easy scale of any part complexity that is required.
The internal portion of the connector that interfaces with the top groove has barbs to grip the cut material inside the needle punched PET panel. This material is softer than the outside skin of the finished needle punched PET panel. The material is squeezed onto the barbs by the outside clip.
Needle punched PET panel material is also deformed around the top of the internal portion above the barbs—this material is deformed by a top rib inside the clip (either single or two-part). There is space above the internal barbs to move this material into. The withdrawal strength is dramatically improved with this feature as the material is compressed by the clip and must be further deformed against the holding force of the outside clip to let the internal portion separate. The connectors provide a captive connection of the fin edge—it is held all around which greatly increases its security of hold.

### Variations

It will of course be realised that while the foregoing has been given by way of illustrative example of this invention, all such and other modifications and variations thereto as would be apparent to persons skilled in the art are deemed to fall within the broad scope and ambit of this invention as is hereinbefore described.

Whilst the invention has been described with reference to needle punched PET acoustic elements, together with moulded PET clips, it can also be used with other thermoplastic acoustic elements provide that the fixing component to be attached to the wall or ceiling is made from the same thermoplastic material as the acoustic elements itself to allow it to be clipped to the thermoplastic material.
A more complicated embodiment may have a two-piece clip. The variant may have two identical parts that interlock from opposing directions (they need not be the same geometry but for simplicity). The clip can be pre-assembled from these two parts and used like a simple clip (assembled from above over the mounting mushroom shaped or similar coupling member) or each half can be assembled onto the top edge of the needle punched PET panel and slid together around the mounting mushroom shaped or similar coupling member. This allows a user to position the internal portion in an approximate position. It can then be fine-tuned in place and final assembly made from the sides or underneath while the fin is in position.
Slitting the top edge of a fin before a complex profile is cut into it allows its opening and removal of any undercut material without damaging the outside face of the fin—the slit allows the material to bend over a longer region to avoid local deformation of the outside skin. This also allows a larger connector barb to be assembled during use without damaging the outside skin in the same way.
When assembled into the rail on the suspension system the outside clip may be held down by the rail. It is also possible to add a feature on the moulded parts to lock the internal portion in place. This may be added to prevent the internal portion with barbs from pushing down into the slot during assembly. It may be a connection between the outside clip and internal portion but could also be a feature to prevent the internal portion from moving into the slot (a depth stop).
Folded Fin Variant—A complex fin profile can be achieved by folding and face bonding a mitre cut needle punched PET panel in addition to the standard grooving process. The advantage of this construction approach is that a pattern printed on the outside can be continued around the underside of the fin from the sides using an unbroken surface. This means that patterns such as timber grain will have a greatly enhanced aesthetic appeal (rather than having a cut edge revealing the needle punched PET panel material). The internal face (partial or whole) of the folded fin is bonded without the use of additional materials or material types to avoid contamination when recycled at end of life.
Adjustment—The connector/clip assembly may be used throughout the length of the fin as the groove will be along its entire length. Ideally adjustment will be made before final assembly of the outside clip on the connector. barbs and clip provide some flexibility, allowing for adjustment of the connector after assembly. The primary strength of the connector lies in its withdrawal resistance, ensuring that it remains securely engaged under load. Its secondary strength comes from its sliding resistance, which helps maintain positional stability within the system.
Endcaps—Having a modest groove or slit means that a clean end look can be achieved without the need for decorative endcaps. Endcaps may use the top groove for attachment. They could be used just to hide any groove profile (if required), to showcase branding or to cover the top portion or the entire cut end of the needle punched PET panel material.
Joiners—These may be configured to be located at the top edge of the fin and share geometry with the endcap connection.
Triple Slot Variant—By cutting two additional slots in the fin, a common connector or clip assembly may be used for both thinner and thicker fins, simplifying component compatibility and reducing the number of unique parts required. Additionally, this design helps to visually obscure the outer clip from the face of the fin, improving the aesthetic appeal of the installation.

1. An acoustic architectural product which can be recycled without dismantling or separation of its component parts, the product comprising an acoustic component and at least one clip or plurality of clips and/or at least one connector or plurality of connectors engaging or configured to physically engage with the acoustic component, wherein the or each clip and/or connector are made from PET.

2. An acoustic architectural product as claimed in claim 1, wherein the acoustic component is a substantially hollow beam folded from a panel of a thermoplastic material, needle punched PET, or a natural fibre based component capable of being recycled and/or upcycled.

3. An acoustic architectural product as claimed in claim 2, wherein the beam is substantially rectangular in cross section.

4. An acoustic architectural product as claimed in claim 2, wherein the beam is configured to be held together by the clip(s), the clip(S) being internal clips moulded from PET.

5. An acoustic architectural product as claimed in claim 2, wherein the beam has a longitudinal groove along a top face into which connectors can be inserted, the connectors being moulded from PET.

6. An acoustic architectural product as claimed in claim 2, wherein the beam has a short internal return on either or each side of the groove.

7. An acoustic architectural product as claimed in claim 6, wherein the clip(s) are resilient and designed to hold the short internal return(s) together.

8. An acoustic architectural product as claimed in claim 1, wherein the connector(s) comprises a holding portion which can be inserted into and held in the groove.

9. An acoustic architectural product as claimed in claim 1, wherein the product comprises a plurality of beams, each beam being a substantially hollow beam folded from a panel of needle punched PET.

10. An acoustic architectural product as claimed in claim 1, wherein the product is or comprises a grid made up of intersecting substantially hollow beams.

11. An acoustic architectural product as claimed in claim 1, wherein the product comprises one or more fins of needle punched PET, each fin having a longitudinal groove along a narrow face of the fin and one or more connectors inserted into the longitudinal groove, the or each connector made solely of PET.

12. A suspension system suitable for suspending acoustic elements from a structure without the need for additional bracing comprising at least one dropper bracket that is capable of being connected to the structure over and connectable to a dropper tube, the dropper tube being connectable to a rail bracket which in turn can support a rail which is connectable to and can support a PET connector of an acoustic architectural product.

13. A suspension system as claimed in claim 12, wherein the at least one dropper bracket has a swivel connection between its mounting and a socket adapted to receive the dropper tube to provide at least one degree of freedom of movement of the socket relative to the mounting.

14. A suspension system as claimed in claim 13, wherein the at least one dropper bracket is configured to allow two degrees of freedom of movement of the socket relative to the mounting.

15. A suspension system as claimed in claim 12, wherein the rail has a symmetrical cross section defining a pair of longitudinal grooves, one groove being configured to retail a rail bracket and the other groove being configured to support a coupling member of the ET connector of the acoustic architectural product.
